(19) United States
(12) Patent Application Publication
(10) Pub. No.: US 2025/0209546 A1
(43) Pub. Date: Jun. 26, 2025

(54) INFORMATION PROCESSING APPARATUS, INFORMATION PROCESSING METHOD, AND NON-TRANSITORY COMPUTER READABLE STORAGE MEDIUM

(71) Applicant: LY Corporation, Tokyo (JP)

(72) Inventors: Risa TAKEUCHI, Tokyo (JP); Reiko KAYAMA, Tokyo (JP); Shizuna ITO, Tokyo (JP); Yukiko TAKANISHI, Tokyo (JP); Yuki TAKEDA, Tokyo (JP); Ken TAKAHASHI, Tokyo (JP); Ryo MOTOZAWA, Tokyo (JP)

(21) Appl. No.: 18/951,314

(22) Filed: Nov. 18, 2024

(30) Foreign Application Priority Data
Dec. 20, 2023 (JP) 2023-215165

(51) Int. Cl. G06Q 50/00; G06Q 30/0601

(52) U.S. Cl. CPC G06Q 50/01; G06Q 30/0641

(57) ABSTRACT

An information processing apparatus according to the present application includes an acquisition unit, a selection unit, and a recommendation unit. The acquisition unit acquires a use history of a user, the use history being related to buying and selling of merchandise. The selection unit selects another user to be recommended by inputting, to generative AI, a first prompt instructing selection of another user having a use history similar to that of the user. The recommendation unit recommends that the user follow the other user selected by the selection unit.

### CROSS-REFERENCE TO RELATED APPLICATIONS

The present application claims priority to and incorporates by reference the entire contents of Japanese Patent Application No. 2023-215165 filed in Japan on Dec. 20, 2023.

### BACKGROUND OF THE INVENTION

### 1. Field of the Invention

The present invention relates to an information processing apparatus, an information processing method, and a non-transitory computer readable storage medium.

### 2. Description of the Related Art

A technique for determining a similar user having a predetermined similarity to a target user and for thereby providing information indicating a predetermined tendency of the similar user on the basis of predetermined information on the similar user has been known conventionally.
Patent Literature 1: Japanese Patent No. 6092360

However, because this conventional technique is not premised on services related to buying and selling of merchandise, for example, the conventional technique has had room for further improvement in providing services that are in line with interests and tastes of users and that the users feel safe with.

### SUMMARY OF THE INVENTION

An information processing apparatus according to the present disclosure includes: an acquisition unit that acquires a use history of a user, the use history being related to buying and selling of merchandise; a selection unit that selects another user to be recommended by inputting a first prompt to generative AI, the first prompt instructing selection of another user having a use history similar to the use history of the user; and a recommendation unit that recommends that the user follow the other user selected by the selection unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating an example of a configuration of an information processing system according to an embodiment;

FIG. 2 is a diagram illustrating an example of information processing (a first embodiment) according to the embodiment;

FIG. 3 is a diagram illustrating an example of information processing (a second embodiment) according to the embodiment;

FIG. 4 is a diagram illustrating an example of a configuration of a terminal device according to the embodiment;

FIG. 5 is a diagram illustrating an example of a configuration of an information processing apparatus according to the embodiment;

FIG. 6 is a diagram illustrating an example of a use history storage unit according to the embodiment;

FIG. 7 is a diagram illustrating an example of a profile screen storage unit according to the embodiment;

FIG. 8 is a flowchart illustrating an example of the information processing (the first embodiment) according to the embodiment;

FIG. 9 is a flowchart illustrating an example of the information processing (the second embodiment) according to the embodiment; and

FIG. 10 is a hardware configuration diagram illustrating an example of a computer that implements functions of the information processing apparatus.

### DETAILED DESCRIPTION OF THE PREFERRED EMBODIMENTS

Modes for implementing an information processing apparatus, an information processing method, and an information processing program, according to the present application (hereinafter, referred to as “embodiments”) will hereinafter be described in detail while reference is made to the drawings. The information processing apparatus, the information processing method, and the information processing program, according to the present application are not to be limited by these embodiments. With respect to the following embodiments, the same reference sign will be assigned to parts that are the same and redundant description thereof will be omitted.

### Embodiments

### 1. Configuration of Information Processing System

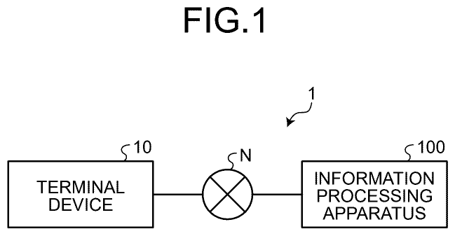

An information processing system 1 illustrated in FIG. 1 will be described first. As illustrated in FIG. 1, the information processing system 1 includes a terminal device 10 and an information processing apparatus 100. The terminal device 10 and the information processing apparatus 100 are communicably connected to each other by wire or wirelessly via a predetermined communication network (a network N). FIG. 1 is a diagram illustrating an example of a configuration of the information processing system 1 according to an embodiment.

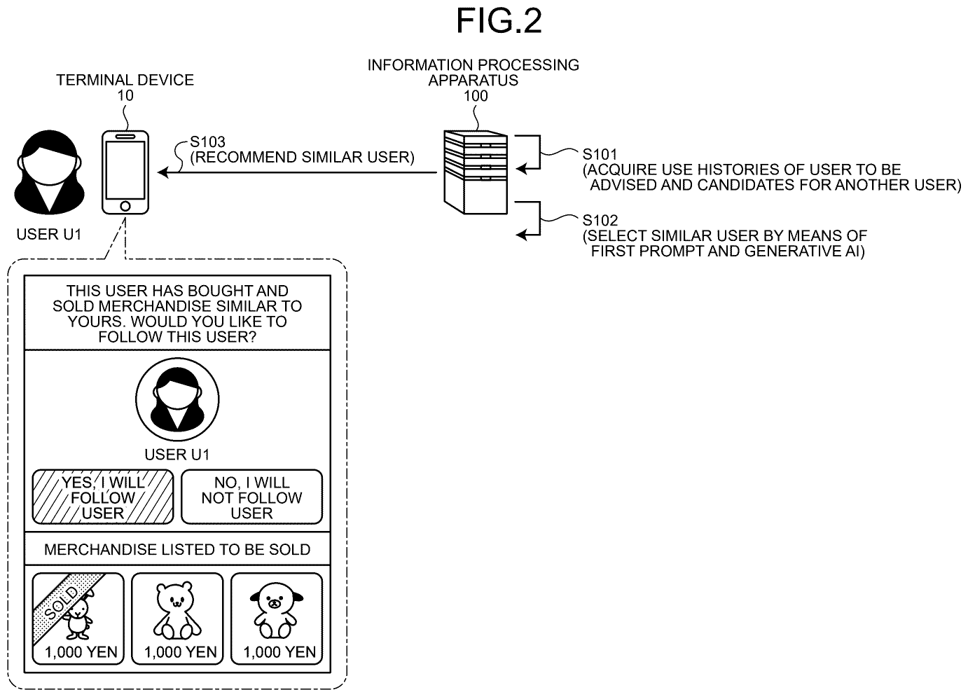

The terminal device 10 is an information processing device used by a user who uses a service enabling buying and selling of merchandise (for example, shopping, an auction, or a flea market, implemented on the Internet). For example, on that service, the user sells a piece of merchandise that the user liked and bought in the past, and buys a piece of merchandise that the user likes and wants at present. For example, the user sells a piece of merchandise that the user bought in the past, the piece of merchandise being of a certain genre, and buys a piece of merchandise that has just been launched, the piece of merchandise being of the same genre, or a piece of merchandise that was launched in the past but the user was unable to buy then. Furthermore, for example, the user sells a piece of merchandise that the user bought in the past, the piece of merchandise being of a certain genre, and buys a piece of merchandise that the user wants, the piece of merchandise being of a genre that the user likes at present. The terminal device 10 may be any device that is capable of implementing processing according to the embodiment. The terminal device 10 may be a device, such as a smartphone, a tablet device, a notebook PC, a desktop PC, a mobile phone, or a PDA. FIG. 2 illustrates a case where the terminal device 10 is a smartphone.

The terminal device 10 is, for example, a portable terminal device that is a smart device, such as a smartphone or a tablet, and that is capable of performing communication with any server apparatus via a wireless communication network of, for example, the fourth generation or the fifth generation (4G or 5G) or Long Term Evolution (LTE). The terminal device 10 may have a screen that is, for example, a liquid crystal display, and that has a touch panel function, and receive various kinds of operation on displayed data including content, the various kinds of operation being, for example, tap operation, slide operation, and scroll operation from the user through the user's finger or a stylus. In FIG. 2, the terminal device 10 is used by a user U1.

The information processing apparatus 100 is an information processing apparatus for the purpose of providing a service that is in line with interests and tastes of users and that the users feel safe with and may be any apparatus that is capable of implementing processing according to the embodiment. Users who buy and sell similar merchandise can be presumed to have similar interests and tastes. The information processing apparatus 100 provides a service that is in line with interests and tastes of users and that the users feel safe with by matching users buying and selling similar merchandise. Specifically, the information processing apparatus 100 acquires use histories of users, the use histories being related to buying and selling of merchandise, inputs the acquired use histories to generative AI, and thereby selects another user (or other users) having a use history similar to that of the user. The information processing apparatus 100 then recommends that the user follow that other user. By following the other user, for example, when the other user lists a piece of merchandise to be sold, the user is able to check what the piece of merchandise is without delay. The information processing apparatus 100 is, for example, an information processing apparatus that provides a service enabling buying and selling of merchandise.

The generative AI is, for example, a text generative model that has been trained with data published on the Internet. For example, the generative AI is a generative pre-trained transformer (GPT) model that generates answers to questions. Such a model generates an answer to a question from data published on the Internet. New data are published every day on the Internet and answers generated by the model are thus updated every day. That is, even if the same question is asked, different answers will be generated, because data referred to by the model when the model generates an answer differ depending on the time the question is asked. The model is capable of providing detailed answers to questions in a wide range of areas and is thus asked a wide variety of questions by users.

FIG. 1 illustrates a case where the terminal device 10 and the information processing apparatus 100 are separately provided but the terminal device 10 and the information processing apparatus 100 may be integrated with each other.

### 2. Example of Information Processing

A technique for determining a similar user having a predetermined similarity to a target user and for thereby providing information indicating a predetermined tendency of the similar user on the basis of predetermined information on the similar user has been known conventionally. However, because this conventional technique is not premised on services related to buying and selling of merchandise, for example, the conventional technique has had room for further improvement in providing services that are in line with interests and tastes of users and that the users feel safe with. The present application is made in view of the above and an object thereof is to provide a service that is in line with interests and tastes of users and that the users feel safe with. According to the present application, users buying and selling similar merchandise are matched. Matching users buying and selling similar merchandise enables provision of a service in line with interests and tastes of the users. Matching users buying and selling similar merchandise leads to the users feeling safe (because a higher sense of security is provided than when a user deals with a user having completely different interests and tastes) and thus also enables provision of a service that the users feel safe with. In embodiments described hereinafter, for example, a user is a user who wants connection between users having the same interests and tastes.

Two kinds of information processing will hereinafter be described as information processing by the information processing system 1 according to the embodiment. The first kind of information processing (a first embodiment) is information processing for matching similar users and the second kind of information processing (a second embodiment) is information processing for generating a profile screen. In the second kind of information processing, for example, a profile screen of a user is generated according to a use history of a similar user selected by the first kind of information processing. Combining these two kinds of information processing enables matching between similar users according to use histories of users and thus enables a profile screen to be generated, the profile screen being suited to a use history of a user.

### First Embodiment: Information Processing for Matching Similar Users

FIG. 2 is a diagram illustrating an example of information processing according to the first embodiment by the information processing system 1. The information processing apparatus 100 acquires a use history of the user U1 on a predetermined service enabling buying and selling of merchandise (Step S101). For example, the information processing apparatus 100 acquires a use history of the user U1, the use history being related to buying and selling of merchandise on a predetermined service. For example, in a case where the user U1 has purchased a piece of merchandise, “xx1”, on a date, “xx2”, from a seller, “xx3”, who may be a user, at a price of “xx4” yen, the information processing apparatus 100 acquires a use history indicating that the user U1 has purchased the piece of merchandise, “xx1”, on the date, “xx2”, from the user, “xx3”, at the price of “xx4” yen. In a case where the user U1 has sold a piece of merchandise, “yy1”, on a date, “yy2”, to a buyer, “yy3”, who may be a user, at a price of “yy4” yen, the information processing apparatus 100 acquires a use history indicating that the user U1 has sold the piece of merchandise, “yy1”, on the date, “yy2”, to the buyer, “yy3”, who may be a user, at the price of “yy4” yen.

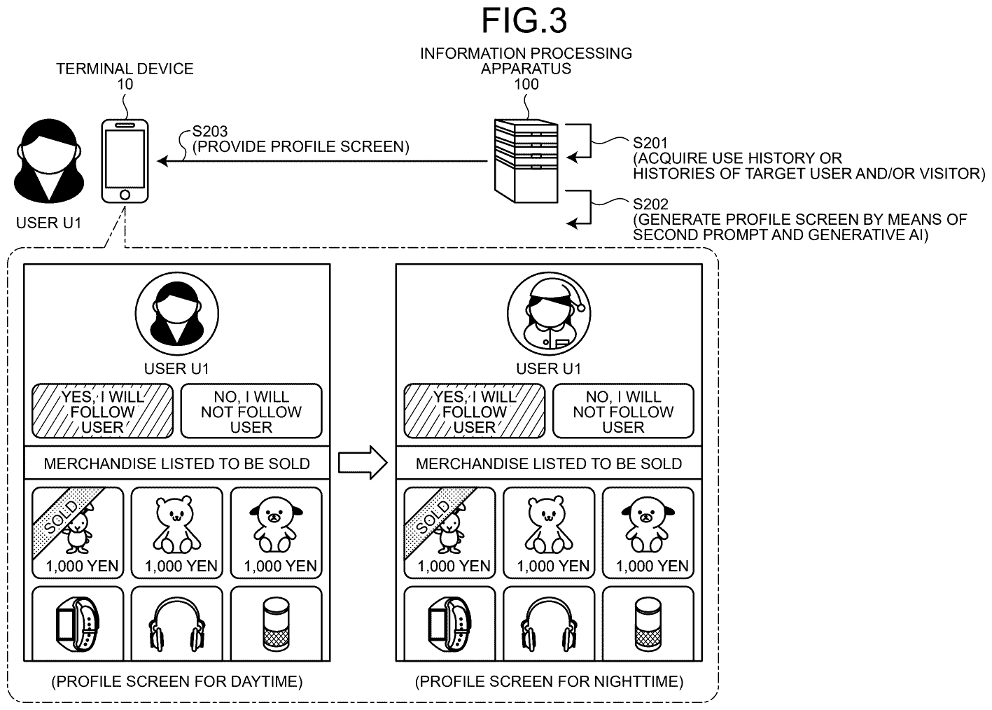

Variations of the use history according to the first embodiment will be described next. The use history according to the first embodiment may include any of histories on a predetermined service enabling buying and selling of merchandise (which may be not a specific predetermined service) or on another service (which may be not a service enabling buying and selling of merchandise), the histories being, for example: a browsing history of the user U1; a purchase history (a purchase history of shopping); a search history (which may include information on, for example, a category often searched by the user U1); a registration history of registration of things that the user U1 wants to sell/buy; a review history of reviews (for example, “likes” widely used on social networking services (SNSs)) made by the user U1; a registration history of registration into a wish list by the user U1; search conditions (which may be a history of search conditions) saved by the user U1; hashtags (which may be a history of hashtags) “followed” (“followed” as widely used on SNSs) by the user U1; and a goods exchange history of goods exchanges (which may be goods exchanges resulting from matching according to offers/requests for goods) made by the user U1. The information processing apparatus 100 may acquire, for example, the use history including any of such histories. The information processing apparatus 100 may acquire the use history including, for example, a review history for information predefined in association with pieces of merchandise, the information being, for example, hashtags. The variations of the use history according to the first embodiment are not limited to these examples and may include, for example, a use history described by reference to FIG. 3.

The information processing apparatus 100 selects another user to be recommended by inputting, together with the acquired use history of the user U1, a prompt (hereinafter referred to as a “first prompt” as appropriate) instructing selection of another user having a use history similar to that of the user U1, into the generative AI (Step S102). In this selection of the other user, candidates for this other user have been specified beforehand, and the other user is selected from these candidates. The first prompt is, in other words, a prompt instructing selection of another user that the user U1 is advised to follow. In a specific example, the first prompt is text of instructions that read, “Please select a user advised to be followed by a user to be advised, from the following candidates for another user. A candidate for another user to be recommended is desirably a person who has bought and sold merchandise similar to that by the user to be advised.”. The information processing apparatus 100 selects another user to be recommended by inputting, into the generative AI, the use history of the user to be advised (the “user U1” in the first embodiment), use histories of the candidates for another user, and the first prompt. Specifically, the information processing apparatus 100 selects, as the other user to be recommended, another user output by the generative AI.

The information processing apparatus 100 then provides information related to the other user selected (for example, information for recommending the other user) to the user U1 (Step S103). For example, the information processing apparatus 100 may transmit information for advising the user U1 to follow the other user selected (for example, information that reads, “This user has bought and sold merchandise similar to yours. Would you like to follow this user?”), to the terminal device 10. Upon receipt of the information transmitted from the information processing apparatus 100, the terminal device 10 causes the received information to be displayed. In a case where the user U1 has followed the other user recommended as described above, the information processing apparatus 100 may make a notification when a piece of merchandise is listed to be sold by the other user, the notification being related to listing of the piece of merchandise to be sold. In making the notification, the information processing apparatus 100 may make a notification of new listing of a piece of merchandise to be sold by the other user followed or make a notification using merchandise content. As described above, the information processing apparatus 100 is capable of advising a user to follow another user according to a match between a thing that the user wants to sell and a thing that the other user wants to buy, for example. Furthermore, the information processing apparatus 100 is capable of advising a user to follow another user to enable exchange of goods with just fees for use of the service and postage, without money transactions between the users.

### Second Embodiment: Information Processing for Generation of Profile Screen

FIG. 3 is a diagram illustrating an example of information processing according to the first embodiment by the information processing system 1. In FIG. 3, the purpose is to automatically generate a profile screen suited to an image of a target user (a “user U1” in the second embodiment). In FIG. 3, the profile screen of the target user is generated according to a use history (which may be the use history of the other user (similar user) selected in FIG. 2) of, for example, a visitor who has browsed a profile screen or merchandise content of the target user, and the profile screen of the target user is thus able to be made look rich and good. Furthermore, in a case where browsing of pieces of merchandise listed to be sold by the target user and access to the merchandise content are possible from the profile screen, the pieces of merchandise listed to be sold by the target user are able to be made to look rich and good. Enabling the profile screen to look rich and good enables the profile screen to catch users' eyes more and enables anyone to generate a high-quality profile screen with a certain quality level maintained.

The information processing apparatus 100 acquires information on (for example, a use history or use histories of) the user U1 and/or the visitor (for example, the other user selected in FIG. 2) (Step S201). The following description is on variations of the use history according to the second embodiment. The use history according to the second embodiment may include any of histories that are, for example: a purchase history (for example, a history of purchases at a flea market) of the user U1 and/or the visitor; a list of pieces of merchandise being listed to be sold by the user U1 and/or the visitor; a history of settlement of accounts using a predetermined application for the user U1 and/or the visitor; a history of transportation rides (for example, a log of transfer information) of the user U1 and/or the visitor; a search history of the user U1 and/or the visitor; a merchandise list of pieces of merchandise “liked” by the user U1 and/or the visitor; search conditions saved by the user U1 and/or the visitor; and an article list of articles (for example, news articles) “followed” by the user U1 and/or the visitor. The information processing apparatus 100 may acquire, for example, the use history including any of such histories. The variations of the use history according to the second embodiment are not limited to these examples and may include, for example, the use history described by reference to FIG. 2.

The information processing apparatus 100 generates a profile screen of the user U1 who is the target user, by inputting, together with the use history acquired, a prompt (hereinafter, referred to as a “second prompt” as appropriate) instructing generation of a profile screen of the target user from the use history, into generative AI (Step S202). The second prompt is, in other words, a prompt instructing generation of a profile screen suited to the use history of the user U1. In a specific example, the second prompt is text of an instruction that reads, “Please generate a profile screen of the target user, the profile screen being suited to the target user, from the use history of the target user.”, or text of an instruction that reads, “Please generate a profile screen of the target user, the profile screen being suited to the target user, from the use history of the visitor.”. The information processing apparatus 100 generates the profile screen of the user U1 who is the target user, by inputting the use history of the target user (the “user U1” in the first embodiment) and/or the use history of the visitor, and the second prompt, into the generative AI. Specifically, the information processing apparatus 100 generates, as the profile screen of the user U1, a profile screen output by the generative AI.

The information processing apparatus 100 then provides the profile screen generated, to the user U1 (Step S203). For example, the information processing apparatus 100 transmits information for causing the generated profile screen to be displayed at the terminal device 10, to the terminal device 10. Upon receipt of the information transmitted from the information processing apparatus 100, the terminal device 10 causes the profile screen to be displayed on the basis of the information received.

### First Variation of Information Processing

In the above described embodiment, the information processing apparatus 100 may generate, for example, an avatar of the user U1 who is the target user, or a background of the profile screen, by inputting a prompt to the generative AI (the profile screen including the avatar or the background of the profile screen thus generated may be generated), the prompt instructing generation of an avatar of the target user or a background of the profile screen. For example, the information processing apparatus 100 may generate the avatar of the user U1 by using a prompt instructing generation of an avatar of the target user wearing a piece of merchandise purchased by the target user. In generating the avatar, for example, the information processing apparatus 100 may use a prompt instructing generation of a profile screen resulting in branding of the user listing merchandise to be sold. Furthermore, for example, the information processing apparatus 100 may change the background of the profile screen of the user U1 who is the target user, by inputting a prompt to the generative AI, the prompt instructing the background of the profile screen of the target user to be changed. In changing the background, for example, the information processing apparatus 100 may use a prompt instructing the design to be changed according to a line of fashion listed to be sold (for example, to change to a monochromatic line, a line making a distinctive impression, or a line making a retro impression). Furthermore, for example, the information processing apparatus 100 may use a prompt instructing a change in the design according to merchandise being listed to be sold (for example, in a case where the target user has many character figures, a change to a background with character figures listed to be sold in the past). Furthermore, for example, the information processing apparatus 100 may use a prompt instructing the design to be randomly changed according to a line of merchandise purchasable at present (at the selling site) (for example, in a case where merchandise to be sold change according to the time of the year, like at a flea market). Furthermore, for example, the information processing apparatus 100 may use a prompt instructing a change in the design according to features of a particular locality.

In the above described embodiment, the information processing apparatus 100 may generate, for example, a profile icon of the user U1 who is the target user (a profile screen including the profile icon thus generated may be generated) by inputting a prompt to the generative AI, the prompt instructing generation of a profile icon of the target user. For example, the information processing apparatus 100 may generate the profile icon of the user U1 by using a prompt instructing generation of a profile icon suited to a selling state of the target user. In generating the profile icon, for example, the information processing apparatus 100 may use a prompt instructing a change in the design (a change to a background having an image, like “selling”, in a case where the target user has been listing a lot of merchandise most recently) according to the selling state of the target user.

In the above described embodiment, the information processing apparatus 100 may generate, for example, an image of the home of the user U1 who is the target user (a profile screen including the image of the home thus generated may be generated) by inputting a prompt to the generative AI, the prompt instructing generation of an image of the home of the target user. For example, the information processing apparatus 100 may generate the image of the home of the user U1 by using a prompt instructing generation of an image of the home of the target user, the image being suited to merchandise purchased by the target user in the past and the floor plan of the home. In generating the image of the home, for example, the information processing apparatus 100 may use a prompt instructing a change in the design (a change to a background having an image based mainly on merchandise purchased most recently) according to a purchase history of the target user.

In the above described embodiment, the information processing apparatus 100 may generate, for example, a hashtag suited to the user U1 who is the target user (a profile screen including the hashtag thus generated may be generated) by inputting a prompt to the generative AI, the prompt instructing generation of a hashtag for the target user. For example, the information processing apparatus 100 generate the hashtag of the user U1 by using a prompt instructing generation of a hashtag suited to merchandise or brands being listed to be sold by the target user. In generating the hashtag, for example, the information processing apparatus 100 may use a prompt instructing a change to a hashtag according to a state of a list of merchandise being listed to be sold by the target user (for example, a change to a hashtag suited to merchandise or brands listed to be sold most recently).

In the above described embodiment, the information processing apparatus 100 may generate the profile screen of the user U1 who is the target user, by inputting, to the generative AI, a prompt instructing a change in how the avatar of the target user looks according to the time the profile screen of the target user is seen. For example, the information processing apparatus 100 may generate the profile screen of the user U1 by using a prompt instructing generation of an avatar capable of having conversations in words that change every day, using a browsing history or current topics. Furthermore, for example, the information processing apparatus 100 may generate the profile screen of the user U1 by using a prompt instructing generation of an avatar that looks as if the avatar is riding on a train when the user U1 is riding on a train. In generating such a profile screen, for example, the information processing apparatus 100 may use a prompt instructing a change in how the avatar looks according to the time of day the profile screen of the target user is seen (for example, a change to an image of the avatar in pajamas when the profile screen is seen at night).

### Second Variation of Information Processing

In the above described embodiment, the information processing apparatus 100 may generate a profile screen of a target user according to a degree of match between use histories of the target user and a visitor. For example, the information processing apparatus 100 may generate the profile screen of the user U1 who is the target user, by inputting, to the generative AI, a prompt instructing generation of a profile screen by placement of higher weight on a use history of a visitor having a higher degree of match among visitors (generation of a profile screen having preferentially listed thereon, pieces of merchandise (pieces of merchandise listed to be sold by the target user) suited to the use history of the visitor having the higher degree of match). In generating this profile screen, for example, the information processing apparatus 100 may generate the profile screen including information on the degree of match, to cause the degree of match to be displayed. Furthermore, for example, the information processing apparatus 100 may change the profile screen according to a visitor. For example, the information processing apparatus 100 may change the profile screen so that pieces of merchandise being listed to be sold by the target user are displayed in order suited to a use history of the visitor. The information processing apparatus 100 may thus change the profile screen so that pieces of merchandise are displayed in order suited to interests and tastes of each visitor, for example.

### 3. Configuration of Terminal Device

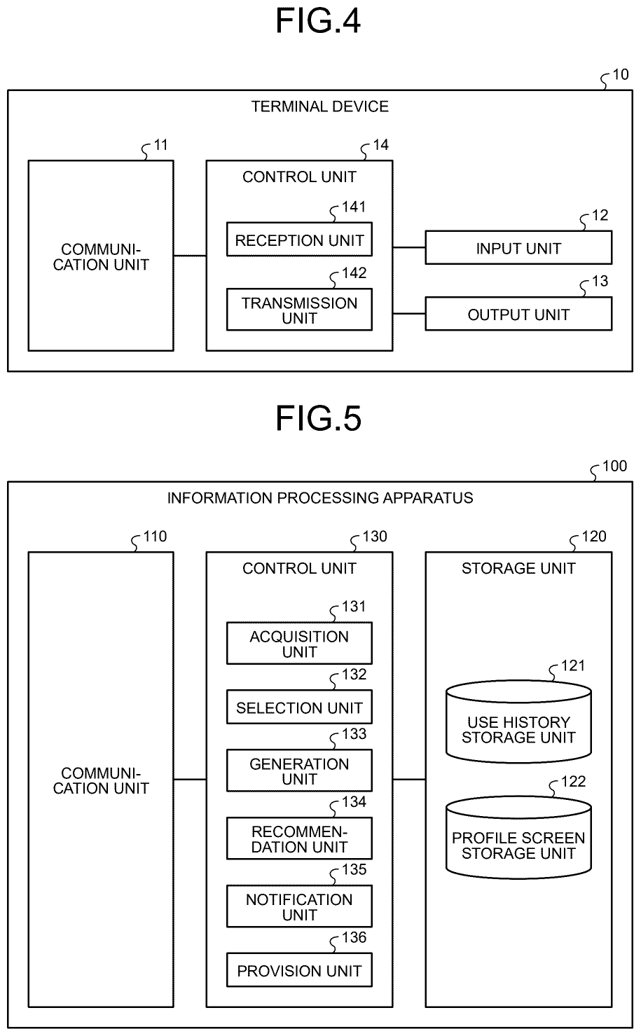

A configuration of the terminal device 10 according to the embodiment will be described next by use of FIG. 4. FIG. 4 is a diagram illustrating an example of the configuration of the terminal device 10 according to the embodiment. As illustrated in FIG. 4, the terminal device 10 has a communication unit 11, an input unit 12, an output unit 13, and a control unit 14.

### Communication Unit 11

The communication unit 11 is implemented by, for example, a network interface card (NIC). The communication unit 11 is connected by wire or wirelessly to a predetermined network N and transmits and acquires information to and from the information processing apparatus 100, for example, via the predetermined network N.

### Input Unit 12

The input unit 12 receives various kinds of operation from a user. In FIG. 2 and FIG. 3, the input unit 12 receives various kinds of operation from the user U1. For example, the input unit 12 may receive various kinds of operation from a user via a display surface by means of a touch panel function. The input unit 12 may receive various kinds of operation from buttons provided on the terminal device 10 or a keyboard and a mouse that are connected to the terminal device 10. For example, the input unit 12 receives operation for following another user.

### Output Unit 13

The output unit 13 is a display device that is a display screen of a tablet device and that is for displaying various kinds of information, the display screen being implemented by, for example, a liquid crystal display or an organic electroluminescence (EL) display. For example, the output unit 13 displays information transmitted from the information processing apparatus 100. For example, the output unit 13 displays information for recommending another user selected as a similar user by the information processing apparatus 100. Furthermore, for example, the output unit 13 displays a profile screen generated by the information processing apparatus 100.

### Control Unit 14

The control unit 14 is, for example, a controller, and is implemented by, for example, various programs being executed by a central processing unit (CPU) or a micro processing unit (MPU), with a random access memory (RAM) serving as a work area, the various programs having been stored in a storage device in the terminal device 10. For example, these various programs include an application program installed on the terminal device 10. For example, these various programs include an application program for causing information (for example, information for recommending another user or a profile screen) to be displayed, the information having been transmitted from the information processing apparatus 100. Furthermore, for example, the control unit 14 is implemented by an integrated circuit, such as an application specific integrated circuit (ASIC) or a field programmable gate array (FPGA).

As illustrated in FIG. 4, the control unit 14 has a reception unit 141 and a transmission unit 142, and implements or executes information processing described hereinafter.

### Reception Unit 141

The reception unit 141 receives, for example, information transmitted from the information processing apparatus 100. For example, the reception unit 141 receives information for recommending another user selected as a similar user. Furthermore, for example, the reception unit 141 receives information for causing a generated profile screen to be displayed.

### Transmission Unit 142

The transmission unit 142 transmits, for example, information on operation performed by a user. For example, the transmission unit 142 transmits information on operation performed by a user to follow another user.

### 4. Configuration of Information Processing Apparatus

A configuration of the information processing apparatus 100 according to the embodiment will be described next by use of FIG. 5. FIG. 5 is a diagram illustrating an example of the configuration of the information processing apparatus 100 according to the embodiment. As illustrated in FIG. 5, the information processing apparatus 100 has a communication unit 110, a storage unit 120, and a control unit 130. The information processing apparatus 100 may have input units that receive various kinds of operation from an administrator of the information processing apparatus 100 (for example, a keyboard and a mouse) and a display unit (for example, a liquid crystal display) for displaying various kinds of information.

### Communication Unit 110

The communication unit 110 is implemented by, for example, an NIC. The communication unit 110 is connected by wire or wirelessly to the network N and transmits and acquires information to and from the terminal device 10, for example, via the network N.

### Storage Unit 120

The storage unit 120 is implemented by, for example: a semiconductor memory element, such as a RAM or a flash memory; or a storage device, such as a hard disk or an optical disk. As illustrated in FIG. 5, the storage unit 120 has a use history storage unit 121, and a profile screen storage unit 122.

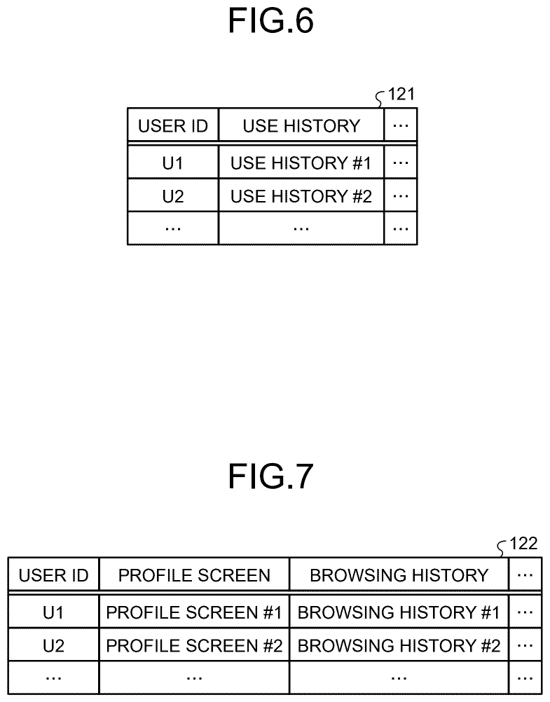

The use history storage unit 121 stores information related to use histories of users. FIG. 6 illustrates an example of the use history storage unit 121 according to the embodiment. The information stored in the use history storage unit 121 is used for, for example, selecting a similar user. As illustrated in FIG. 6, the use history storage unit 121 has items, such as “user ID” and “use history”.

The item, “use ID”, indicates identification information for identifying users. The item, “use history”, indicates use histories of the users. In the example illustrated in FIG. 6, conceptual pieces of information, such as “use history #1” and “use history #2”, are stored for “use history”, but in actuality, information, such as “purchased merchandise: merchandise “xx1”, purchased time: date “xx2”, seller: user “xx3”, purchased price: “xx4” yen . . . ”, for example, is stored.

The profile screen storage unit 122 stores information related to profile screens of users. FIG. 7 illustrates an example of the profile screen storage unit 122 according to the embodiment. The information stored in the profile screen storage unit 122 is used for generating a profile screen, for example. As illustrated in FIG. 7, the profile screen storage unit 122 has items, such as “user ID”, “profile screen”, and “browsing history”.

The item, “use ID”, indicates identification information for identifying the users. The item, “profile screen”, indicates profile screens of the users. In the example illustrated in FIG. 7, conceptual pieces of information, such as “profile screen #1” and “profile screen #2”, are stored for “profile screen”, but in actuality, sets of image data on the profile screens are stored, for example. Uniform resource locators (URLs) where the sets of image data are located or file pass names indicating locations where the sets of image data are stored may be stored as the sets of image data on the profile screens, for example. The item, “browsing history”, indicates browsing histories of the profile screens. In the example illustrated in FIG. 7, conceptual pieces of information, such as “browsing history #1” and “browsing history #2”, are stored for “browsing history”, but in actuality, information, such as “visitor: user “zz1”, browsed time: date “zz2”, . . . ”, is stored.

### Control Unit 130

The control unit 130 is a controller and is implemented by, for example, various program being executed by a CPU or an MPU, for example, with a RAM serving as a work area, the various programs having been stored in a storage device in the information processing apparatus 100. The control unit 130 is implemented by, for example, an integrated circuit, such as an ASIC or FPGA.

As illustrated in FIG. 5, the control unit 130 has an acquisition unit 131, a selection unit 132, a generation unit 133, a recommendation unit 134, a notification unit 135, and a provision unit 136, and implements or executes information processing described hereinafter. The internal configuration of the control unit 130 is not limited to the configuration illustrated in FIG. 5, and may be any other configuration that implements the information processing described later.

### Acquisition Unit 131

The acquisition unit 131 acquires various kinds of information from the storage unit 120. The acquisition unit 131 stores the various kinds of information acquired, into the storage unit 120.

The acquisition unit 131 acquires various kinds of information from an external information processing apparatus. The acquisition unit 131 acquires various kinds of information from another information processing device, such as the terminal device 10.

For example, the acquisition unit 131 acquires use histories of a user (a user to be advised) and candidates for another user. For example, the information processing apparatus 100 acquires use histories of a user and candidates for another user, the use histories being related to buying and selling of merchandise on a predetermined service. The acquisition unit 131 acquires, for example, a prompt (a first prompt) instructing selection of another user (from the candidates for another user) having a use history similar to that of the user. The acquisition unit 131 thus acquires, for example, the first prompt, together with the use histories of the user and the candidates for another user. These pieces of information are then input to the generative AI for matching similar users.

The acquisition unit 131 acquires, for example, information (such as a use history) on a visitor who has browsed a profile screen of the user, for example. For example, the information processing apparatus 100 acquires a prompt (a second prompt) instructing generation of a profile screen of the user from the use history. The acquisition unit 131 thus acquires, for example, the second prompt, together with the use history or use histories of the user and/or the visitor. These pieces of information are then input to the generative AI for generating a profile screen.

### Selection Unit 132

The selection unit 132 selects another user to be recommended by, for example, inputting the use histories acquired by the acquisition unit 131 and the first prompt to the generative AI. Specifically, the selection unit 132 selects another user to be recommended by inputting the use history of the user, the use histories of the candidates for another user, and the first prompt, to the generative AI. The selection unit 132 selects, as the other user to be recommended, another user output by the generative AI.

### Generation Unit 133

The generation unit 133 generates a profile screen of the target user, by inputting, for example, the use history or histories acquired by the acquisition unit 131 and the second prompt, to the generative AI. Specifically, by inputting, to the generative AI, the use history or histories of the user and/or the visitor and the second prompt, the generation unit 133 generates the profile screen of the target user. The generation unit 133 generates, as the profile screen of the target user, a profile screen output by the generative AI.

### Recommendation Unit 134

The recommendation unit 134 recommends, for example, another user selected by the selection unit 132. For example, the recommendation unit 134 provides information related to another user selected (information for recommending another user). For example, the recommendation unit 134 provides information for recommending that the user follow the other user selected.

### Notification Unit 135

The notification unit 135 makes, for example, a notification related to listing of a piece of merchandise to be sold by the other user recommended by the recommendation unit 134 when the piece of merchandise is listed to be sold. For example, in a case where the user has followed the other user recommended, the notification unit 135 makes a notification related to listing of a piece of merchandise to be sold by the other user when the piece of merchandise is listed to be sold. For example, the notification unit 135 makes a notification of new listing of a piece of merchandise to be sold by the other user. Furthermore, for example, the notification unit 135 provides merchandise content for the piece of merchandise newly listed to be sold by the other user.

### Provision Unit 136

The provision unit 136 provides, for example, the profile screen generated by the generation unit 133, to the user. For example, the provision unit 136 provides information for causing the generated profile screen to be displayed.

### 5. Flow of Information Processing

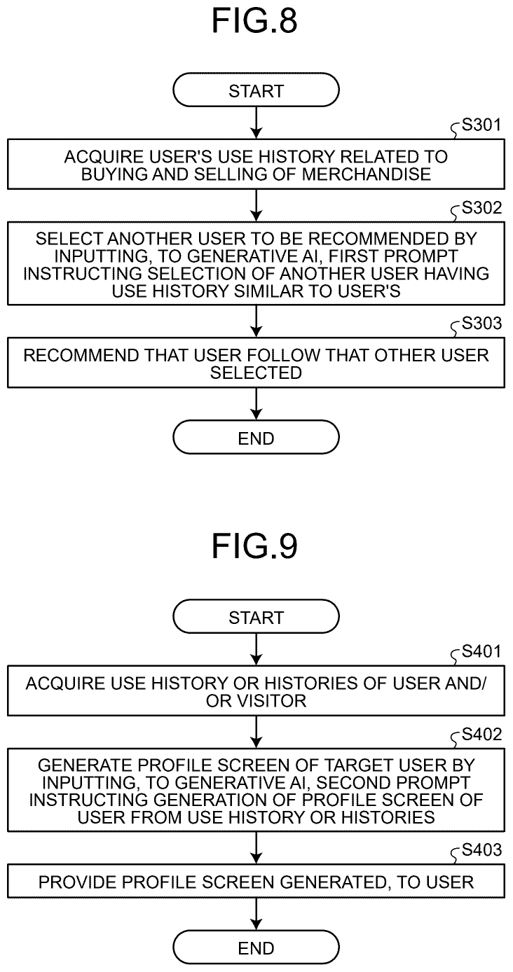

A procedure of information processing by the information processing system 1 according to the embodiment will be described next by use of FIG. 8 and FIG. 9. FIG. 8 and FIG. 9 are flowcharts illustrating procedures of the information processing by the information processing system 1 according to the embodiment (the first embodiment and the second embodiment).

As illustrated in FIG. 8 (the first embodiment), the information processing apparatus 100 acquires a use history of a user, the use history being related to buying and selling of merchandise (Step S301).

By inputting a first prompt instructing selection of another user having a use history similar to that of the user to the generative AI, the information processing apparatus 100 selects another user to be recommended (Step S302).

The information processing apparatus 100 recommends that the user follow the other user selected (Step S303).

As illustrated in FIG. 9 (the second embodiment), the information processing apparatus 100 acquires a use history or use histories of the user and/or a visitor (Step S401).

By inputting a second prompt instructing generation of a profile screen of the user from the use history or use histories to the generative AI, the information processing apparatus 100 generates a profile screen of the target user (Step S402).

The information processing apparatus 100 provides the profile screen generated, to the user (Step S403).

### 6. Effects

As described above, the information processing apparatus 100 according to the embodiment has the acquisition unit 131, the selection unit 132, and the recommendation unit 134. The acquisition unit 131 acquires a use history of a user, the use history being related to buying and selling of merchandise. By inputting a first prompt instructing selection of another user having a use history similar to that of the user to the generative AI, the selection unit 132 selects another user to be recommended. The recommendation unit 134 recommends that the user follow the other user selected by the selection unit 132.

The information processing apparatus 100 according to the embodiment thereby enables matching between users buying and selling similar merchandise and is thereby able to provide a service that is in line with interests and tastes of the users and that the users feel safe with.

Furthermore, the acquisition unit 131 acquires the use history including a history of reviews made by the user on a service enabling buying and selling of merchandise, the reviews being on information predefined in association with pieces of merchandise.

The information processing apparatus 100 according to the embodiment thereby enables matching in consideration of the history of the reviews made by the user on the information related to the merchandise, for example, and is thereby able to provide a service that the users feel even safer with.

Furthermore, the information processing apparatus 100 according to the embodiment further has the notification unit 135 that makes a notification when a piece of merchandise is listed to be sold by the other user recommended by the recommendation unit 134, in a case where the user has followed the other user, the notification being related to the listing of the piece of merchandise.

The information processing apparatus 100 according to the embodiment thereby enables notification when the other user who has sold and bought similar merchandise newly lists a new piece of merchandise to be sold, for example, and is thereby able to provide a service that the users feel even safer with.

Furthermore, the information processing apparatus 100 according to the embodiment further has the generation unit 133 that generates a profile screen of the user by inputting a second prompt instructing generation of a profile screen suited to the use history of the user.

The information processing apparatus 100 according to the embodiment thereby enables, for example, anyone to generate a high-quality profile screen with a certain quality level maintained and is thereby able to provide a service that the users feel even safer with.

Furthermore, the generation unit 133 generates the profile screen of the user by inputting, to the generative AI, the second prompt instructing generation of the profile screen from information on a visitor who has browsed the profile screen of the user or merchandise content of merchandise listed to be sold by the user.

The information processing apparatus 100 according to the embodiment thereby enables generation of a profile screen suited to the use history of the user from the use history of the visitor and is thereby able to provide a service that the users feel even safer with.

Furthermore, the generation unit 133 generates the profile screen of the user by inputting, to the generative AI, the second prompt instructing generation of the profile screen by placing higher weight to information on a visitor having a higher degree of match with the user, the visitor being among visitors.

The information processing apparatus 100 according to the embodiment thereby enables, for example, generation of the profile screen suited to the use history of the user by placing higher importance to the use history of the visitor having the higher degree of match with the user and is thereby able to provide a service that the users feels even safer with.

### 7. Hardware Configuration

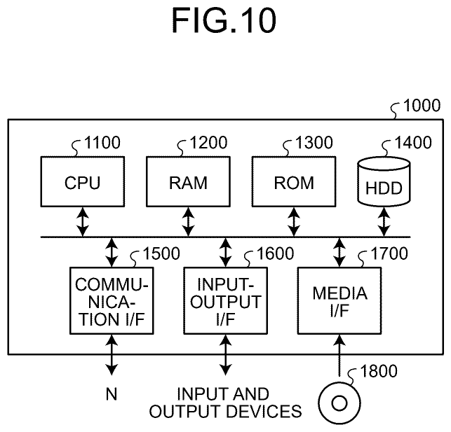

The above described information processing apparatus 100 according to the embodiment is implemented by, for example, a computer 1000 having a configuration illustrated in FIG. 10. FIG. 10 is a hardware configuration diagram illustrating an example of a computer that implements functions of the information processing apparatus 100. The computer 1000 has a CPU 1100, a RAM 1200, a ROM 1300, an HDD 1400, a communication interface (I/F) 1500, an input-output interface (I/F) 1600, and a media interface (I/F) 1700.

The CPU 1100 operates on the basis of programs stored in the ROM 1300 or the HDD 1400 and controls each unit. The ROM 1300 stores a boot program executed by the CPU 1100 when the computer 1000 is booted, and a program dependent on hardware of the computer 1000, for example.

The HDD 1400 stores a program executed by the CPU 1100 and data used by the program, for example. The communication interface 1500 acquires data from another device via a predetermined communication network and sends the data to the CPU 1100, and transmits data generated by the CPU 1100 to another device via a predetermined communication network.

The CPU 1100 controls, via the input-output interface 1600, output devices, such as a display and a printer, and input devices, such as a keyboard and a mouse. The CPU 1100 acquires data from the input devices via the input-output interface 1600. Furthermore, the CPU 1100 outputs data generated, to the output devices via the input-output interface 1600.

The media interface 1700 reads a program or data stored in a recording medium 1800 and provides the program or data read, to the CPU 1100 via the RAM 1200. The CPU 1100 loads the program into the RAM 1200 from the recording medium 1800 via the media interface 1700 and executes the program loaded. The recording medium 1800 is, for example: an optical recording medium, such as a digital versatile disc (DVD) or a phase change rewritable disk (PD); a magneto-optical recording medium, such as a magneto-optical (MO) disk; a tape medium; a magnetic recording medium; or a semiconductor memory.

For example, in a case where the computer 1000 functions as the information processing apparatus 100 according to the embodiment, the CPU 1100 of the computer 1000 implements functions of the control unit 130 by executing a program loaded into the RAM 1200. The CPU 1100 of the computer 1000 reads and executes such programs from the recording medium 1800, but in another example, the CPU 1100 may acquire these programs from another apparatus via a predetermined communication network.

### 8. Others

Of the processing described above with respect to the embodiments described above, all or part of any processing described as being performed automatically may be performed manually, or all or part of any processing described as being performed manually may be performed automatically by a publicly known method. In addition, the processing procedures, the specific names, and the information including the various data and parameters described above and illustrated in the drawings may be modified in any way unless otherwise particularly stated. For example, the various kinds of information illustrated in the drawings are not limited to the information illustrated therein.

Furthermore, the components of each apparatus/device in the drawings have been illustrated functionally and/or conceptually, and are not necessarily physically configured as illustrated in the drawings. That is, specific modes of distribution and integration of each apparatus/device are not limited to those illustrated in the drawings, and all or part thereof may be configured to be distributed or integrated functionally or physically in any units according to various loads and use situations.

Furthermore, the embodiments described above may be combined, as appropriate, so long as no contradictions arise in the processing from the combination.

Some of embodiments of the present application have been described in detail above on the basis of the drawings, but these are just examples, and the present invention may be implemented in other modes that have been modified or improved in various ways on the basis of the modes described in the section, Detailed Description of the Preferred Embodiments, and knowledge of those skilled in the art.

Furthermore, any “unit”, “section”, or “module” mentioned above may be read as a “means” or a “circuit”. For example, an acquisition unit may be read as an acquisition means or an acquisition circuit.

According to one aspect of an embodiment, an effect of enabling provision of a service that is in line with interests and tastes of users and that the users feel safe with is achieved.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing apparatus, including:
an acquisition unit that acquires a use history of a user, the use history being related to buying and selling of merchandise;
a selection unit that selects another user to be recommended by inputting a first prompt to generative AI, the first prompt instructing selection of another user having a use history similar to the use history of the user; and
a recommendation unit that recommends that the user follow the other user selected by the selection unit.

2. The information processing apparatus according to claim 1, wherein the acquisition unit acquires the use history including a history of reviews made by the user on information predefined in association with the merchandise on a service enabling buying and selling of the merchandise.

3. The information processing apparatus according to claim 1, further including a notification unit that makes a notification when a piece of merchandise is listed to be sold by the other user recommended by the recommendation unit in a case where the user has followed the other user, the notification being related to listing of the piece of merchandise to be sold.

4. The information processing apparatus according to claim 1, further including a generation unit that generates a profile screen of the user by inputting, to the generative AI, a second prompt instructing generation of a profile screen suited to the use history of the user.

5. The information processing apparatus according to claim 4, wherein the generation unit generates the profile screen of the user by inputting, to the generative AI, the second prompt instructing generation of the profile screen from information on visitors who have browsed a profile screen of the user or merchandise content of merchandise listed to be sold by the user.

6. The information processing apparatus according to claim 5, wherein the generation unit generates the profile screen of the user by inputting, to the generative AI, the second prompt instructing generation of the profile screen by placing higher weight to information on a visitor with a higher degree of match with the user, the visitor being among the visitors.

7. An information processing method executed by a computer and including:
an acquisition process of acquiring a use history of a user, the use history being related to buying and selling of merchandise;
a selection process of selecting another user to be recommended by inputting a first prompt to generative AI, the first prompt instructing selection of another user having a use history similar to the use history of the user; and
a recommendation process of recommending that the user follow the other user selected by the selection process.

8. A non-transitory computer readable storage medium having stored an information processing program that causes a computer to execute:
an acquisition step of acquiring a use history of a user, the use history being related to buying and selling of merchandise;
a selection step of selecting another user to be recommended by inputting a first prompt to generative AI, the first prompt instructing selection of another user having a use history similar to the use history of the user; and
a recommendation step of recommending that the user follow the other user selected through the selection step.
